(19) United States
(12) Patent Application Publication
(10) Pub. No.: US 2026/0146883 A1
(43) Pub. Date: May 28, 2026

(54) INTEGRATED BLOWER SENSOR UNIT FOR LAPTOP

(71) Applicant: ORIENTAL SYSTEM TECHNOLOGY INC., Hsin-Chu (TW)

(72) Inventors: Chun-Chiang CHEN, Zhubei City (TW); Yu-Chih LIANG, Hsinchu City (TW); Wen-Chie HUANG, Hualien County (TW); Chein-Hsun WANG, Hsin-Chu (TW); Jenping KU, Hsinchu County (TW)

(21) Appl. No.: 19/023,326

(22) Filed: Jan. 16, 2025

Related U.S. Application Data
(60) Provisional application No. 63/725,438, filed on Nov. 26, 2024.

(51) Int. Cl. G01F 1/69; G01J 5/00; G01J 5/12; G01J 5/20; G06F 1/20

(52) U.S. Cl. CPC G01F 1/69; G01J 5/0014; G01J 5/12; G01J 5/20; G06F 1/203

(57) ABSTRACT

An integrated blower sensor unit is proposed that provides air temperature sensing and air flow (or mass) sensing for external Fan speed and ON/OFF control to offer sustained optimized computing power for AI laptop. The air temperature sensor can be either resistive-type sensor or thermopile sensor. The air flow sensor consists of two resistive-type sensor elements plus one resistive heater element that co-located on a Membrane made of MEMS process with cavity underneath. A signal processing element is also provided that performs amplification, analog to digital conversion, storage of calibration parameters, sequence control of sensor readout and calculation of calibrated readout data through a serial communication interface. The integrated blower sensor unit is mounted in the in-flow air way of a blower for the AI laptop.

### CROSS-REFERENCE TO RELATED APPLICATION

This patent application claims the benefit of U.S. Provisional Patent Application No. 63/725,438 , filed Nov. 26, 2024, which is incorporated by reference herein.

### BACKGROUND OF THE DISCLOSURE

### Technical Field

The present disclosure relates to an integrated blower sensor unit with a non-contact thermal sensor and an air flow sensor for a laptop to offer sustained and optimized computational power.

### Description of Related Art

Apart from the central processing unit (CPU) and the graphics processing unit (GPU), AI laptop further has a neural processing unit (NPU). The overall computing capability needs to be at least 45 TOPS (tera operations per second) or higher to process real-time voice and video signal. With the rapid increased larger inference model after AI training, the need of computing power is greatly increased, and the power consumption is relatively increased by 2-3 times as well, for example, 80-300 Watt for AI laptop. The processor of AI laptop includes CPU for general task management, GPU (graphic processor unit) for parallel computation of audio/video signal as well as NPU for inference of AI models. Therefore, the heat management for laptop is becoming important to prevent the chip from overheating and downclocking, which may significantly downgrade the computing power and might impact user experience significantly.

The implementation of heat management for laptop is different from that of desktop computer or AI server. Conventional heat management for desktop computer and AI server can use water-cooling manner or the mixed manner of water cooling and air cooling. AI lap top can only use fan cooling for heat management due to the height and weight constraints of AI laptop. Traditional gaming laptop adopted the manners of increasing the volume of metal casing and/or continually activating the fan has problem of fan noise which greatly impacts the user experience.

Alternative approach is using the build-in temperature sensor of CPU chip or a thermistor attached to the casing to control the activation and/or speed of the fan. However, those may be close to the heat source, and the severe temperature change may generate annoying fan switching noise. More importantly, AI generation output might have severe delay due to computing power is affected by the over-heated chip. Therefore, a complete solution is needed for applying to AI laptop to provide optimized sustained computing power and to decrease fan noise.

For traditional fan cooling in laptop, a thermistor and a fan speed control are used to optimize the computational power for laptop. However, the traditional way may not be able to estimate the condition accurately. Hence, there is a need for the integrated blower sensor unit within the blower to provide the parameters, such as in-flow air temperature and air mass, to be estimated together with CPU temperature for the optimization of sustainable computing power.

### SUMMARY OF THE INVENTION

The disclosure provides an integrated blower sensor unit, which may sense the in-flow air temperature and the in-flow air volume for laptop to optimize computational power. The laptop (such as AI laptop) may generate significantly amount of heat that needs to be managed carefully to avoid overheating the processing unit and to offer optimized computational power.

One embodiment of the disclosure provides an integrated blower sensor unit that contains a non-contact thermal sensor and an air flow senor to be located in the in-flow air path of a blower. The non-contact thermal sensor is used to sense an in-flow air temperature (Tair), and the air flow sensor is used to sense the in-flow air volume (or mass). The fan speed or ON/OFF of the fan is controlled based on CPU operating temperature, the in-flow air temperature and the in-flow air volume.

In some embodiments, the non-contact thermal sensor of the integrated blower sensor unit may be a thermopile sensor or a resistive-type thermal sensor (such as thermistor). The integrated blower sensor unit of the disclosure is located in the in-flow air path of the blower. The integrated blower sensor unit of the disclosure has a cover cap with two holes for the air flowing therethrough.

In some embodiments, a signal processing element of the integrated blower sensor unit of the disclosure may be a built-in ASIC (application specific integrated circuit) to perform an analog signal processing and/or an analog to digital conversion that provides calibrated digital output of the in-flow air temperature and in-flow air mass (or volume).

In some embodiments, the build-in ASIC may have an analog signal processing unit and a sigma-delta analog to digital converter for converting an analog signal into a digital signal. The integrated blower sensor unit may output through a serial communication interface, such as I²C. During the calibration process, the calibration parameters are stored in the non-volatile memory, such as OTP, MTP, EEPROM or flash memory. The state machine of the build-in ASIC may use the calibrated parameters and the real-time measured sensing data to convert those into readable information for user.

In some embodiments, the integrated blower sensor unit may use the thermopile sensor as the non-contact thermal sensor, which is sealed from the air flow sensor.

In some embodiments, the integrated blower sensor unit may use the stand-alone SMD type thermistor for sensing the in-flow air temperature. The SMD type thermistor may be located on the unit substrate and connected to the build-in ASIC for signal processing and readout.

In some embodiments, the integrated blower sensor unit may use the thermal conductive glue to attach the blower sensor chip to the unit substrate.

In some embodiments, the blower sensor chip and the stand-alone signal processing element (the build-in ASIC) of the integrated blower sensor unit are separate chips in the same package, which the blower sensor chip is mounted vertically on top of the ASIC chip.

In some other embodiments, the blower sensor chip and the ASIC chip are mounted in the same package and in the same plane horizontally.

In summary, the integrated blower sensor unit for the laptop may contain a non-contact thermal sensor, an air flow sensor and/or a signal processing element (such the build-in ASIC) to provide calibrated outputs. The air temperature sensing and the air flow sensing is crucial for fan control in the AI laptop during heat management for providing sustainable computational power of AI tasks computing. The integrated blower sensor unit is located in the in-flow air path of the blower. The integrated blower sensor unit is miniature and provides digital outputs.

### BRIEF DESCRIPTION OF THE DRAWINGS

FIG. 1 the schematic diagram of one embodiment of the structure of the blower sensor chip.

FIG. 2 is the schematic diagram of another embodiment of the structure of the blower sensor chip with thermopile sensor as the non-contact thermal sensor.

FIG. 3 is the perspective view of the integrated blower sensor unit.

FIG. 4(a) and FIG. 4(b) are the perspective views of the integrated blower sensor unit and the blower.

FIG. 5 is the block diagram of the build-in ASIC of the integrated blower sensor unit.

FIG. 6 is the side view of one embodiment of the integrated blower sensor unit with the build-in ASIC and the blower sensor chip glued together vertically.

### DETAILED DESCRIPTION

As used in the present disclosure, terms such as “first”, “second” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second” does not imply any specific sequence or order.

The AI laptop needs a lot of computational power, for example, as least 45-300 TOPS (tera operations per second) for the processing of audio/video input and providing inference of AI tasks. The computational power is generally between 80-300 watts, which needs detailed design of thermal management in order to provide sustainable computational power. For the laptop, the heat management may be performed through fan control, which uses the difference between the in-flow air temperature and the processor (CPU/GPU/NPU) temperature with respect to the in-flow air volume (or mass) to dissipate heat generated from the processor.

The power dissipation capability is largely dependent on the in-flow air volume and temperature difference between working temperature of processor and in-flow air temperature as shown below.

$$P = 20 * Q * Δ T$$

P is the dissipation power, Q is the in-flow air volume in unit of CMM (cubic meter per minute), and ΔT is the temperature difference between working temperature of processor and in-flow air temperature.

The working temperature of the processor may be obtained from the contact type temperature sensor attached to the processor or from inside temperature sensor of processor. Thus, the in-flow air temperature and the in-flow air volume are crucial information for heat management in AI laptop. On the other hand, the in-flow air volume may be obtained from the fan speed, but the information is not accurate enough to be used as the true in-flow air volume. Therefore, the air flow sensor is used in the embodiment as an air mass sensor to accurately provide the information of in-flow air volume for the heat management in the AI laptop.

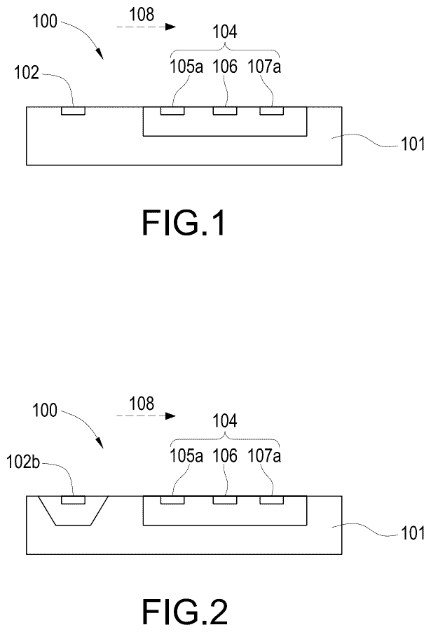

FIG. 1 the schematic diagram of one embodiment of the structure of the blower sensor chip 100. The blower sensor chip 100 may be made by the MEMS process. The blower sensor chip 100 includes a silicon base 101, a non-contact thermal sensor 102 and an air flow sensor 104. The air flows along the direction 108. The air flow sensor 104 has a membrane with two resistive-type sensor elements 105a and 107a disposed on a cavity 103 to sense the in-flow air volume. The resistive heater element (micro heater) 106 is disposed between the sensors 105a and 107a to generate heat. The in-flow air volume is proportional to the resistance difference of resistive-type sensor elements 107a and 105a. Here, the property of resistance change verse temperature (TCR of resistor) is used. The resistance material of the resistive-type sensor elements 105a, 107a and the resistive heater element 106 may be semiconductor process compatible metal, such as platinum, aluminum, copper or nickel, which has temperature coefficient of resistance (TCR) between 0.004 to 0.006 per ° C. change. The cavity 103 may be a V-shape groove and formed by anisotropic wet etching. The air flow sensor 104 works as sensing the difference of heat blown away by air. Therefore, The air flow sensor 104 may accurately estimate the actual in-flow air mass.

FIG. 2 is the schematic diagram of another embodiment of the structure of the integrated blower sensor unit with thermopile sensor 102b as the non-contact thermal sensor. The thermopile sensor 102b is sealed separately from the air flow sensor 104. The thermopile sensor 102b is used to sense the in-flow air temperature by detecting the cap of blower. The thermopile sensor 102b has the cavity separate from the air flow sensor 104.

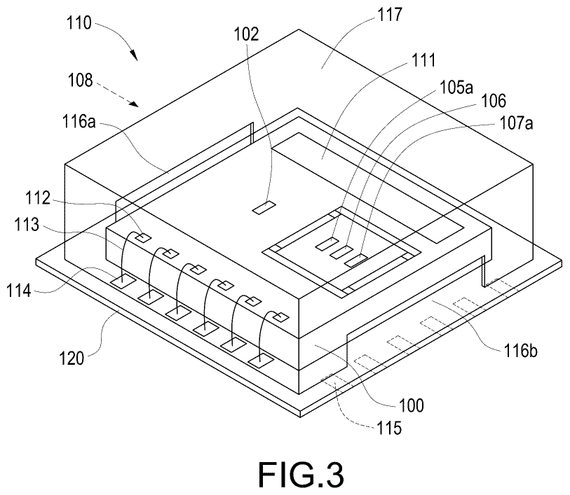

FIG. 3 is the perspective view of the integrated blower sensor unit 110. The integrated blower sensor unit 110 has a unit substrate 120 made of ceramic or PCB, and the blower sensor chip 100 may be attached to the unit substrate 120 with a thermal conductive glue. The blower sensor chip 100 may have multiple bonding pads 112 connected to the pads 114 of the unit substrate 120 through multiple boding wires 113. On the backside (bottom side) of the unit substrate 120, multiple communication pads 115 provide power inputs and communication interface to fan controller logic. On top surface of the unit substrate 120, the cover cap 117 with two holes (openings) 116a and 116b are formed along the in-flow air path (direction 108).

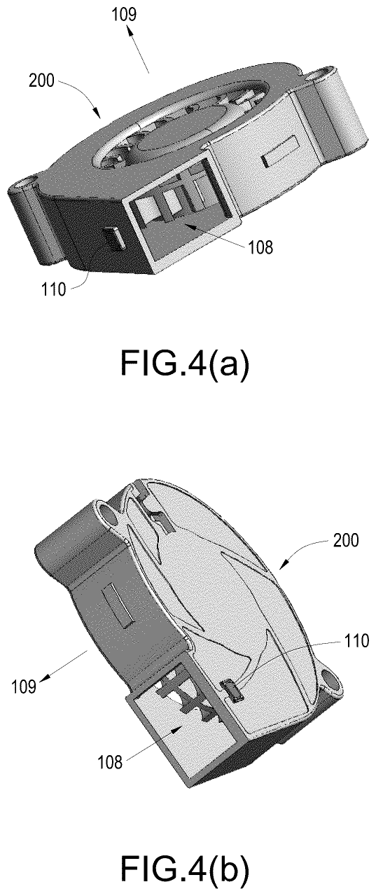

FIG. 4(a) and FIG. 4(b) are the perspective views of the integrated blower sensor unit 110 and the blower 200. The air flows out along direction 109. The integrated blower sensor unit 110 may be installed on the side wall (FIG. 4(b)) or bottom wall (FIG. 4(a)) of the blower 200.

Referring back to FIG. 3, in some embodiments, the blower sensor chip 100 may be incorporated with the build-in ASIC 111 (signal processing element), which supplies digital outputs through the communication pads 115 on the unit substrate.

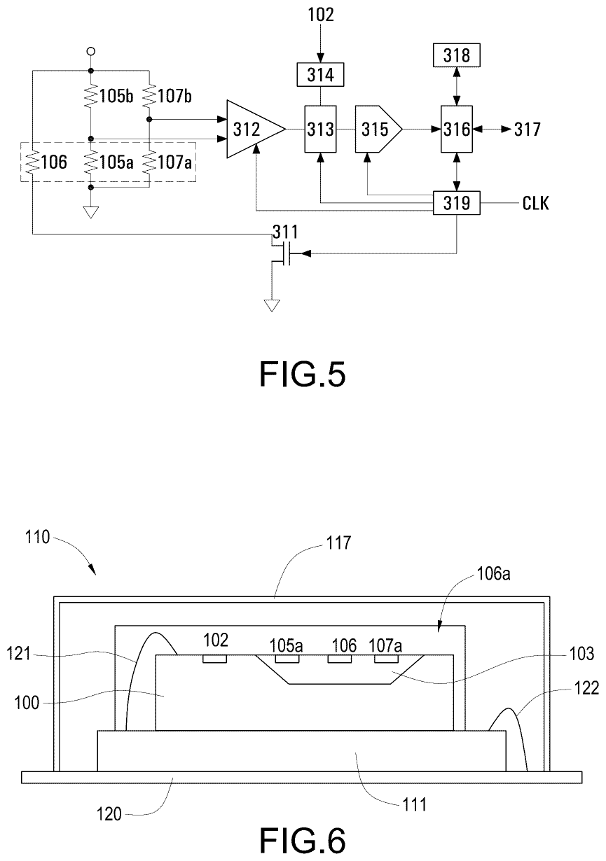

FIG. 5 is the block diagram of the build-in ASIC 111 of the integrated blower sensor unit. The dash line block includes the resistive-type sensor elements 105a, 107a and the resistive heater element 106, which are located on the membrane above the cavity 103 (FIG. 2). The resistive-type sensor elements 105a, 107a act as reference and are configured as a bridge structure for differential detection of air flow. With respect to the direction 108 of air flow, the resistive-type sensor element 105a is cooler than the resistive-type sensor element 107a. The differential voltage between the resistive-type sensor elements 105a, 107a is inputted to the instrumentational amplifier (air flow sensor amplifier) 312, and then passes through the multiplexer 313 and the digital converter (sigma-delta ADC) 315. The converted digital data are temporary stored in the register 316. The communication interface 317 of the build-in ASIC 111 is I²C type, which may be read/written by external microcontroller for the sensor data. The calibration parameters are stored in the nonvolatile memory 318, which may be OTP (one time programming), MTP (multiple times programming), EEPROM (electrically erasable programmable read-only memory) or flash memory. The sequence control logic is implemented by the state machine 319, which controls the selection of signal path in the multiplexer 313, the operation of the SD ADC 315, and the calculation of measured data, the controlling of the resistive heater element 106 through the MOS switch 311. The input from the non-contact thermal sensor 102 is fed to the buffer amplifier (air thermal temperature sensor buffer amplifier) 314, and is selected by the multiplexer 313 to pass through the SD ADC 315 to be converted into digital signals, and then is stored in the register 316 for air temperature output.

In some embodiments, the integrated blower sensor unit 110 may use the stand-alone SMD type thermistor for sensing the in-flow air temperature. The SMD type thermistor may be located on the unit substrate 101 and connected to the buffer amplifier 314 of the build-in ASIC 111 for signal processing and readout.

FIG. 6 is the side view of one embodiment of the integrated blower sensor unit 110 with the build-in ASIC 111 and the blower sensor chip 100 glued together vertically. As shown in FIG. 6, in some embodiments, the integrated blower sensor unit 110 may use a stand-alone ASIC 111 for signal processing, and the blower sensor chip 100 is sitting on top of the build-in ASIC 111 with bonding wire 121. The bonding wires 122 are connected between the build-in ASIC 111 and the unit substrate 120. A cover cap (protection cap) 117 is glued to unit substrate 120 with two holes (openings) 106a and 106b aligned with the direction 108 of air flow.

In some other embodiments, the integrated blower sensor unit 110 may use separate ASIC mounted in same blow sensor unit package with connection to the blower sensor chip in the same plane horizontally.

In summary, the integrated blower sensor unit for AI laptop contains the air temperature sensor (non-contact thermal sensor), the air flow sensor and/or the ASIC for signal processing and providing calibrated outputs. The air temperature and the air flow sensing are crucial for fan control in AI laptop for heat management and to provide sustainable computational power for AI tasks. The integrated blower sensor unit is located in the in-flow air way of the blower which is miniature and providing digital outputs.

While this disclosure has been described by means of specific embodiments, numerous modifications and variations may be made thereto by those skilled in the art without departing from the scope and spirit of this disclosure set forth in the claims.

What is claimed is:

1. An integrated blower sensor unit, used for a laptop and mounted on a side wall or a bottom wall of a blower adjacent to an in-flow air path, and comprising:
a unit substrate, comprising a plurality of power inputs and a plurality of communication pads disposed on a bottom side thereof to be an interface with an external microcontroller;
a blower sensor chip, disposed on the unit substrate, electrically connected to the unit substrate with a plurality of bonding wires, and comprising:
a silicon base, disposed on the unit substrate;
a non-contact thermal sensor, disposed on the silicon base, and configured to sense an in-flow air temperature; and
an air flow sensor, disposed on the silicon base, and comprising a cavity defined on the silicon base and a membrane disposed above the cavity;
a signal processing element, disposed on the unit substrate, connected to the non-contact thermal sensor and the air flow sensor, and configured to perform an analog signal processing and/or an analog to digital conversion with a serial communication interface; and
a cover cap, disposed on the unit substrate, and comprising two holes defined along the in-flow air path.

2. The integrated blower sensor unit according to claim 1, wherein the non-contact thermal sensor is a resistive-type thermal sensor or a thermopile sensor.

3. The integrated blower sensor unit according to claim 1, wherein the air flow sensor comprises two resistive-type sensor elements and one resistive heater element disposed between the two resistive-type sensor elements.

4. The integrated blower sensor unit according to claim 3, wherein the two resistive-type sensor elements are located on the membrane disposed above the cavity and aligned with a direction of the in-flow air path.

5. The integrated blower sensor unit according to claim 3, wherein the two resistive-type sensor elements and the one resistive heater element are made of platinum, aluminum, copper or nickel metal.

6. The integrated blower sensor unit according to claim 1, wherein the signal processing element is horizontally collocated with the blower sensor chip.

7. The integrated blower sensor unit according to claim 1, the signal processing element and the blower sensor chip are disposed separately, and the blower sensor chip is mounted on the signal processing element.

8. The integrated blower sensor unit according to claim 1, wherein the signal processing element and the blower sensor chip are disposed separately, and the signal processing element and the blower sensor chip are mounted on the unit substrate adjacent to each other.

9. The integrated blower sensor unit according to claim 1, wherein the blower sensor chip is attached to unit substrate by a thermal conductive glue.

10. The integrated blower sensor unit according to claim 1, further comprising:
a SMD type thermistor, mounted on the unit substrate and connected to the signal processing element, and configured to sense the in-flow air temperature.

11. The integrated blower sensor unit according to claim 1, wherein the signal processing element comprises an air flow sensor amplifier, an air thermal temperature sensor buffer amplifier, a multiplexer, a sigma-delta ADC, a nonvolatile memory, an I²C interface and a state machine for a sequence control.

12. The integrated blower sensor unit according to claim 11, wherein the nonvolatile memory comprises an OTP, a MTP, a EEPROM or a flash memory, and is configured to store a plurality of calibration parameters.

13. The integrated blower sensor unit according to claim 12, wherein the state machine is configured to use the calibration parameters stored in the nonvolatile memory and a real-time measured sensing data to calculate a calibrated data.

14. The integrated blower sensor unit according to claim 11, wherein the state machine is configured to control one resistive heater element of the air flow sensor through a built-in MOS switch during a measurement process.
